(19) United States
(12) Patent Application Publication
(10) Pub. No.: US 2026/0309238 A1
(43) Pub. Date: Oct. 8, 2026

(54) PURGE AIR SEALING VALVE

(71) Applicant: GM Global Technology Operations LLC, Detroit, MI (US)

(72) Inventors: David Prettenhofer, Michigan Center, MI (US); Thomas D. Bronchetti, Auburn Hills, MI (US); Anthony Prettenhofer, Pinckney, MI (US)

(73) Assignee: GM Global Technology Operations LLC, Detroit, MI (US)

(21) Appl. No.: 19/173,715

(22) Filed: Apr. 8, 2025

(51) Int. Cl. F16K 3/22; F16K 3/30; H01M 8/04746

(52) U.S. Cl. CPC F16K 3/22; F16K 3/30; H01M 8/04761; H01M 2250/20

(57) ABSTRACT

A valve assembly is provided and includes a valve body including a first conduit extending between a first opening of the first conduit and a second opening of the first conduit with respect to a first axis and a second conduit communicatively coupled to the first conduit and extending along a second axis between a first opening of the second conduit and a second opening of the second conduit spaced from the first opening of the second conduit. The valve assembly further includes a valve stem extending between a first end and a second end with respect to the first axis, the valve stem being arranged in the first conduit with respect to the first axis and movable between a first position and a second position.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to fuel cell systems and, more particularly, to a valve for a fuel cell system.

Hydrogen fuel cell systems generate electricity from the chemical reaction of hydrogen and oxygen, without producing harmful emissions. Hydrogen fuel cell systems can be used to power various applications, such as vehicles, stationary generators, and portable devices. Hydrogen fuel cell systems offer some advantages such as high efficiency and low noise. While hydrogen fuel cell systems operate well for their intended purpose, further development is possible.

### SUMMARY

In one configuration, a valve assembly is provided and includes a valve body including a first conduit extending between a first opening of the first conduit and a second opening of the first conduit with respect to a first axis and a second conduit communicatively coupled to the first conduit and extending along a second axis between a first opening of the second conduit and a second opening of the second conduit spaced from the first opening of the second conduit. The valve assembly further including a valve stem extending between a first end and a second end with respect to the first axis, the valve stem being arranged in the first conduit with respect to the first axis and movable between a first position and a second position.

The valve assembly may include one or more of the following optional aspects. For example, the valve stem can include a first seal and a second seal spaced from the first seal. The valve stem is in the first position when the first opening of the second conduit is axially between the first seal and the second seal. The valve stem is in the second position when the first seal and the second seal are axially between the first opening of the first conduit and the first opening of the second conduit. The first position of the valve stem prevents fluid flow from the second opening of the first conduit to the second conduit and from the second conduit to the second opening of the first conduit. The second position of the valve stem allows fluid flow between the second opening of the first conduit to the second conduit.

According to at least one aspect, the valve stem can include a base and a head coupled to the base. The valve stem can include an annular groove arranged axially between the head and the base with respect to the first axis. The head can be shearable from the base along the annular groove when valve stem is in the second position. The valve stem cannot return to the first position from the second position.

In another configuration, a valve assembly is provided and includes a valve body including a first conduit extending between a first opening of the first conduit and a second opening of the first conduit with respect to a first axis and a second conduit communicatively coupled to the first conduit and extending transverse to the first conduit along a second axis between a first opening of the second conduit and a second opening of the second conduit spaced from the first opening of the second conduit. The valve assembly further includes a valve stem extending between a first end and a second end with respect to the second axis, the valve stem being arranged in the second conduit with respect to the second axis and movable between a first position and a second position.

The valve assembly may include one or more of the following optional aspects. For example, the second conduit includes a threaded portion extending between the first opening of the second conduit and the second opening of the second conduit. The valve stem can include a first segment coupled to a second segment that can include a threaded portion that corresponds with the threaded portion of the second conduit. The valve stem interrupts flow between the first opening of the first conduit and the second opening of the first conduit when the arranged in the first position.

In at least one example, the valve stem allows flow between the first opening of the first conduit and the second opening of the first conduit when the arranged in the first position.

In another example, the first segment of the valve stem can be shearable from the second segment of the valve stem in the second position.

In yet another configuration, a vehicle is provided and includes a vehicle body extending between a first end and second end, a power reservoir coupled to the vehicle body, an electric motor coupled to the vehicle body and communicatively coupled to the power reservoir, and a hydrogen fuel cell system coupled to the vehicle body and communicatively coupled to the power reservoir. The hydrogen fuel cell system including a stack housing including one or more openings and a valve assembly arranged in one of the one or more openings. The valve assembly including a valve body including a first segment extending along a first axis between a first end and a second end, a second segment communicatively coupled to the first segment between the first end and the second end, and a valve stem arranged in the first segment and between a first position and a second position with respect to the first axis.

The vehicle may include one or more of the following optional aspects. For example, the first position of the valve stem prevents fluid flow from the stack housing to the second segment and from the second segment to the stack housing. The second position of the valve stem allows fluid flow between the stack housing to the second segment. The valve stem cannot return to the first position from the second position.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a fuel cell stack according to principles of the present disclosure;

FIG. 2 is a fragmentary perspective view of the fuel cell stack of FIG. 1 including a valve assembly according to the principles of the present disclosure;

FIG. 3A is a partial exploded view of the valve assembly of FIG. 2 including a valve body and a valve stem;

FIG. 3B is another configuration of a valve body according to the principles of the present disclosure;

FIG. 4 is a cross-sectional view of the valve assembly of FIG. 2;

FIG. 5 is a close-up cross-sectional view of the valve assembly of FIG. 4 at section 5;

FIG. 6 is a close-up cross-sectional view of the valve assembly of FIG. 4 at section 6;

FIG. 7 is a cross-sectional view of the valve assembly of FIG. 2 where the valve stem is arranged at a first position;

FIG. 8 is a cross-sectional view of the valve assembly of FIG. 2 where the valve stem is arranged at a second position;

FIG. 9 is a cross-sectional view of the valve assembly showing a head of the valve stem sheared from a first end;

FIG. 10 is an end view of the valve stem of FIG. 2;

FIG. 11 is an end view of the valve assembly showing the head of the valve stem sheared from the first end;

FIG. 12 is a configuration of a tool for removing the head from first end of the valve stem;

FIG. 13 is a fragmentary perspective view of the fuel cell stack of FIG. 1 and another configuration of a valve assembly according to the principles of the present disclosure;

FIG. 14 is a perspective view of the valve assembly of FIG. 13;

FIG. 15 is a cross-sectional view of the valve assembly of FIG. 14 showing a valve stem in a first position;

FIG. 16 is a cross-sectional view of the valve assembly of FIG. 14 showing the valve stem in a second position;

FIG. 17 is a cross-sectional view of another valve assembly according to the principles of the present disclosure and showing a valve stem in a first position; and

FIG. 18 is a cross-sectional view of the valve assembly of FIG. 17 showing the valve stem in a second position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Testing hydrogen fuel cell systems for leaks can be desirable to ensure proper assembly of a stack housing or an external system such as a stack housing ventilation system, but existing methods are time consuming and leave room for inadvertent mistakes during manufacturing. According to at least some aspects of the present disclosure, a valve assembly that allows for leak testing as well as venting during normal operation is provided. The valve assembly can be installed in a leak testing position and then easily adjusted to a vent position. The valve assembly can be configured so that the valve assembly cannot easily revert to the leak testing position after being adjusted to the vent position.

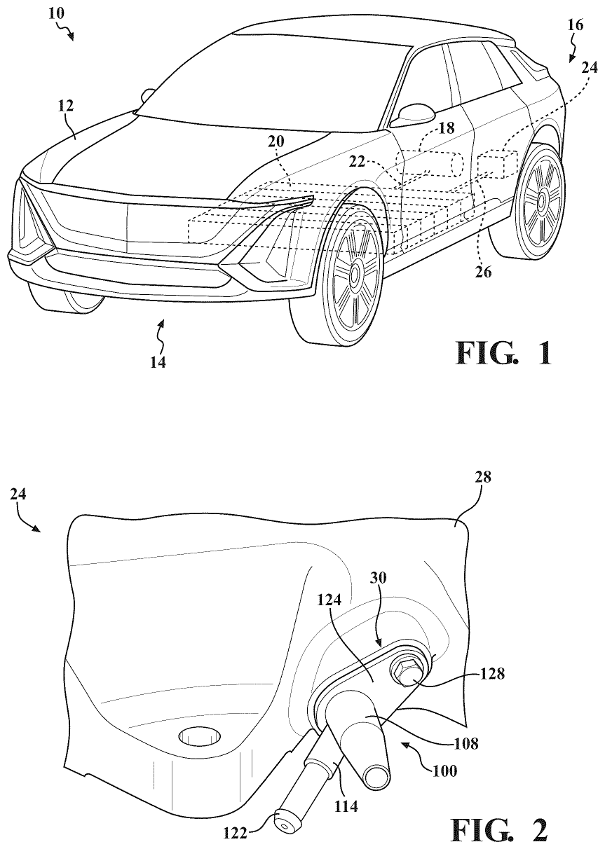

With reference to FIG. 1, an illustrative example of a vehicle 10 is provided. The vehicle 10 includes a vehicle body 12 that extends between a first end 14 and a second end 16. The vehicle 10 includes an electric motor 18 communicatively coupled to a power reservoir 20 via a cable 22. The vehicle 10 also includes a hydrogen fuel cell system 24 arranged in the vehicle body 12 and communicatively coupled to the power reservoir 20 via another cable 26.

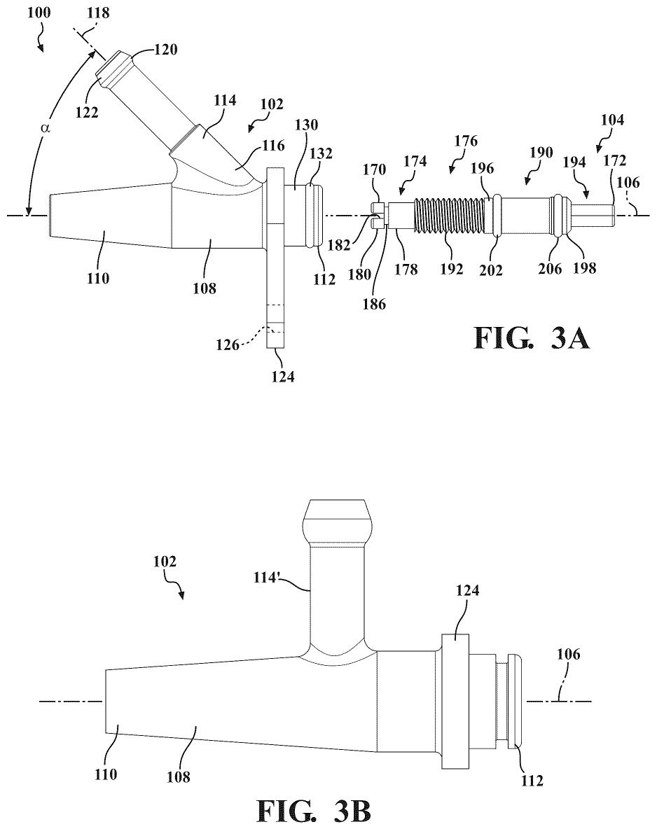

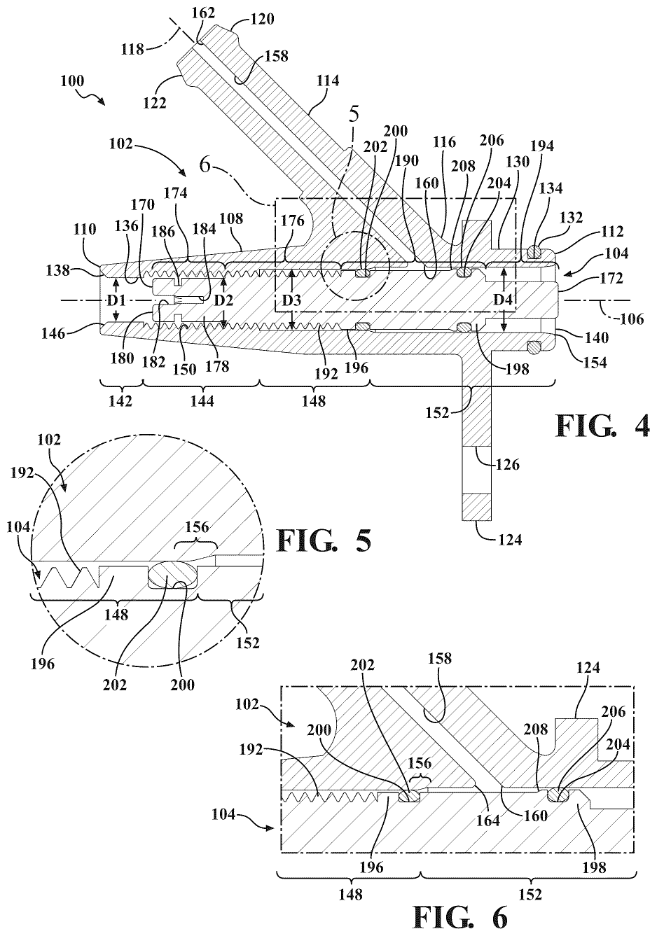

With reference to FIG. 2, the hydrogen fuel cell system 24 includes a stack housing 28 having a chamber that receives a fuel cell stack (not shown). The stack housing 28 includes at least one vent or opening 30 that is communicatively coupled with the chamber. According to at least some of the principles of the present disclosure, a valve assembly 100 can be arranged in the vent 30 and secured to the stack housing 28. The valve assembly 100 can be configured to secure (i.e., close off) the vent 30 for leak testing of the stack housing 28 or to prevent the stack housing 28 from being included in a leak test of an external device (e.g., a ventilation stack housing system). Additionally, the valve assembly 100 is also configured to operate as a pressure purge valve once the hydrogen fuel cell system 24 is commissioned for normal operation. With reference to FIG. 3A, the valve assembly 100 includes a valve body 102 and a valve stem 104 that is configured to be arranged within the valve body 102 along a first or longitudinal axis 106. The valve body 102 includes a first segment 108 extending between a first end 110 and a second end 112 spaced from the first end 110 with respect to the longitudinal axis 106. The valve body 102 also includes a second segment 114 that is fluidly coupled to the valve body 102 at a proximal end 116 and extends away from the first segment 108 along a second axis 118 to a distal end 120. In the present configuration, the second segment 114 is arranged at an angle a with respect to the first axis 106. In at least one configuration, with reference to FIG. 3B, the second segment 114′ can be arranged perpendicular to the first axis 106. The second segment 114 can include a barbed portion 122 that is configured to receive and retain a hose or tubing (not shown) for carrying fluid toward and/or away from the valve assembly 100. The valve body 102 can further include a bracket 124 extending from the first segment 108 and arranged axially between the second segment 114 and the second end 112 with respect to the longitudinal axis 106. The bracket 124 can include one or more openings 126 that are configured to receive fasteners 128 (FIG. 2) for securing the valve body 102 to the stack housing 28, for example. The valve body 102 includes a mounting flange 130 arranged between the second segment 114 and/or the bracket 124 and the second end 112 of the first segment 108. The mounting flange 130 can be configured to include one or more seals 132, which can be desirable for establishing a fluid tight connection between the stack housing 28 and the valve assembly 100, for example. Optionally, as shown in FIG. 4, the one or more seals 132 can be O-ring seals that are configured to be seated in seal grooves 134 arranged in the mounting flange 130. Alternatively, the mounting flange 130 can be configured with a threaded male or female connection, compression fitting, face seal, or another method commonly found in the automotive industry.

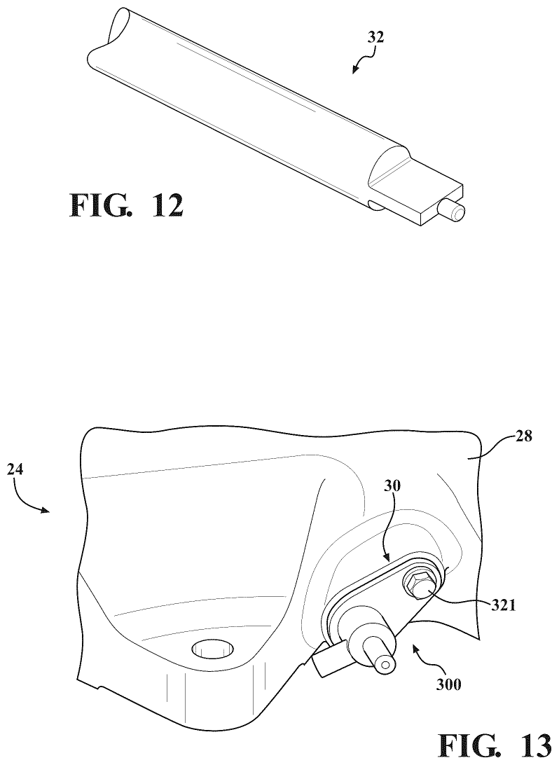

With reference to FIG. 4, the first segment 108 includes a first conduit 136 that extends from a first opening 138 at the first end 110 to a second opening 140 at the second end 112. The first conduit 136 can include one or more sections that are stepped or tapered between the first opening 138 and the second opening 140. For instance, the first conduit 136 can include a first section 142 that extends at a first diameter D1 from the first opening 138 to a second section 144. As discussed in more detail below, the first diameter D1 can be tailored (i.e., sized) to support a portion of the valve stem 104. The first opening 138 can include a rounded or chamfered edge 146 to allow a tool 32 (FIG. 12) to be easily inserted into the first conduit 136 from the first opening 138. The second section 144 extends at a second diameter D2 from the first section 142 to a third section 148. The second section 144 can include threads 150 that correspond with a portion of the valve stem 104. In the present illustrative configuration, the second diameter D2 is larger than the first diameter D1. The third section 148 extends at third diameter D3 from the second section 144 to a fourth section 152. The third diameter D3 can be greater than both the first diameter D1 and the second diameter D2. The fourth section 152 extends at a fourth diameter D4 from the third section 148 to the second opening 140. The fourth diameter D4 can be greater than the first, second, and third diameters D1, D2, D3. The fourth diameter D4 can be selected such that the valve stem 104 and at least a portion of a tool (e.g., a hex bit) can be inserted in the second opening 140 to actuate the valve stem 104 with respect to the valve body 102. Optionally, the second opening 140 can include a rounded or chamfered edge 154 to prevent inadvertent damage to the valve stem 104 (e.g., an O-ring seal) during installation. With reference to FIG. 5, the first conduit 136 can include a transition region 156 that is arranged between the third section 148 and the fourth section 152. The transition region 156 can be configured to ensure that a portion of the valve stem 104 (e.g., an O-ring seal) engages with the third and/or fourth sections 148, 152 of the first conduit 136.

With reference again to FIG. 4, the second segment 114 includes a second conduit 158 that extends from a first opening 160 at the proximal end 116 to a second opening 162 at the distal end 120. A portion of the first opening 160 can include a rounded edge 164 to prevent and/or avoid damage to a portion of the valve stem 104 (e.g., an O-ring) during installation. The position of the first opening 160 of the second conduit 158 can be anywhere along the third and fourth sections 148, 152 of the first conduit 136. More particularly, the first opening 160 of the second conduit 158 can be positioned between the transition region 156 and the second opening 140 of the first conduit 136. As will be discussed in more detail below, the first opening 160 can be located along the first conduit 136 so that a portion of the valve stem 104 can prevent fluid from flowing toward the first opening 138 of the first conduit 136 and the first opening 160 of the second conduit 158.

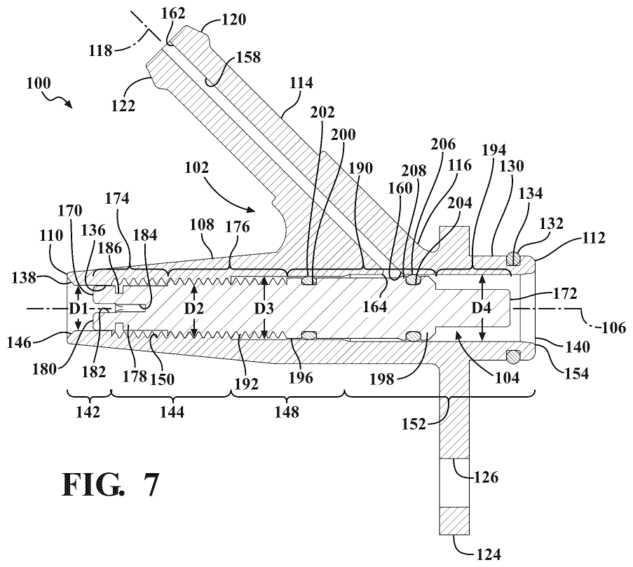

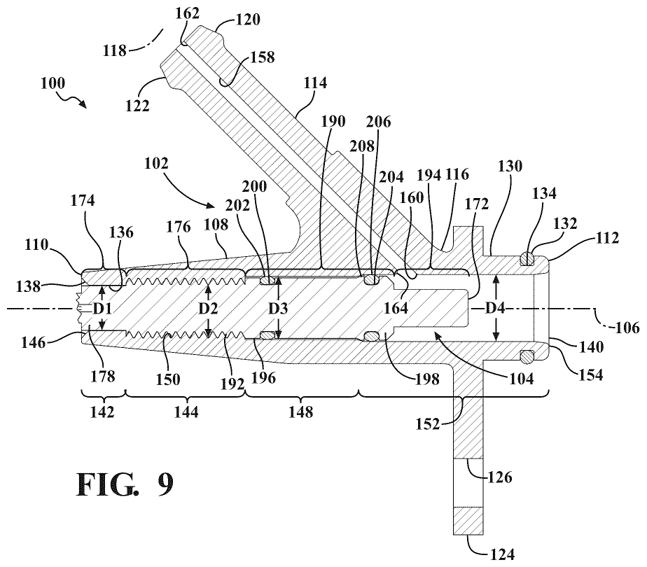

With reference again to FIG. 3A, the valve stem 104 includes a first end 170 and a second end 172 spaced from the first end 170 with respect to the longitudinal axis 106. The valve stem 104 can include one or more sections between the first end 170 and the second end 172 that are configured to engage and/or correspond with the one or more sections 142, 144, 148, 152 of the first conduit 136. For instance, the valve stem 104 includes a first section 174 that extends from the first end 170 toward a second section 176. The first section 174 includes a base 178 and a head 180 coupled to the base 178 and extending toward the first end 170. The head 180 includes a slot 182 that is configured to receive the tool 32 or a screwdriver so that the valve stem 104 can be actuated along the longitudinal axis 106 and toward the first end 110 of the valve body 102. The head 180 and the base 178 can include a central opening 184 extending along the longitudinal axis 106 and configured to receive a portion of the tool 32, for example. The first section 174 includes an annular groove 186 between the head 180 and the base 178. In other words, the head 180 is configured to shear from the base 178 along the annular groove 186 once the valve stem 104 is fully seated within the valve body 102 and the valve assembly 100 is in a vent or open position (FIG. 9). Configuring the head 180 to shear from the base 178 is desirable because it helps prevent inadvertent adjustment of the valve stem 104 with respect to the valve body 102. Stated differently, removing the head 180 with the slot 182 for the tool 32 makes it challenging to inadvertently adjust the valve assembly 100 to a closed position (FIG. 7) during routine maintenance or during a repair, for example. In at least some configurations, the valve stem 104 includes a shear surface 188 (FIG. 11) facing the first opening 138 of the valve body 102 when the head 180 breaks off the base 178. According to one aspect, the shear surface 188 can include a different color (e.g., green) or texture than the rest of the valve stem 104. In doing so, an operator can easily look at the first opening 138 of the valve body 102 and quickly identify and/or confirm that the valve stem 104 is in the open position (FIG. 9).

With reference again to FIG. 3A, the second section 176 extends along the longitudinal axis 106 from the first section 174 to a third section 190. The second section 176 includes threads that correspond with the threads 150 of the third section 148 of the first conduit 136, as shown in FIG. 4. The engagement between the threads 192 of the valve stem 104 and the threads 150 of the valve body 102 help precisely control the depth of the valve stem 104 with respect to the longitudinal axis 106.

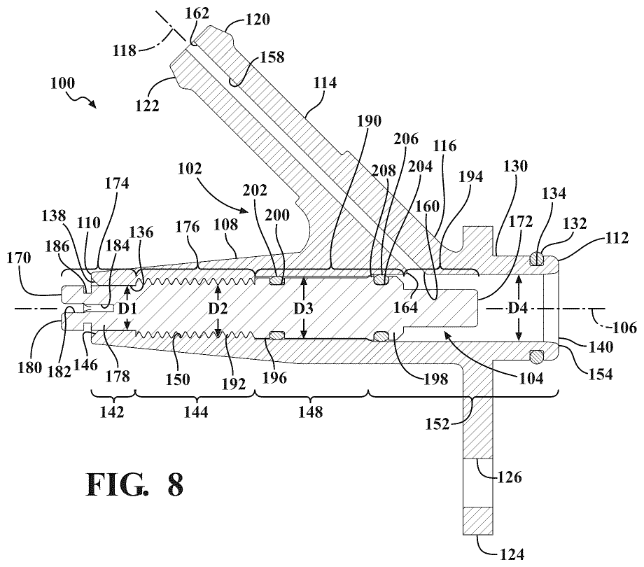

With reference again to FIG. 3A, the third section 190 extends along the longitudinal axis 106 between the second section 176 and a fourth section 194. The third section 190 includes a first end 196 and a second end 198 spaced from the first end 196 with respect to the longitudinal axis 106. The third section 190 includes one or more seals arranged in between the first end 196 and the second end 198. In the present illustrative configuration, with reference to FIG. 4, the third section 190 can include a first seal groove 200 arranged adjacent to the first end 196 and receiving a first seal 202 and a second seal groove 204 arranged adjacent to the second end 198 and receiving a second seal 206. The first seal groove 200 and the second seal groove 204 can be spaced so that the seals 202, 206 straddle the first opening of the second conduit 158 in the closed position (FIG. 7). The first seal 202 and the second seal 206 can be the same diameter or different diameters. According to one aspect, the third section 190 also includes an annular lip 208 on either side of the second seal groove 204 that has a slightly larger diameter than the rest of the third section 190. With reference to FIG. 8, the annular lip 208 is configured to engage with the transition region 156 of the first conduit 136 when the valve stem 104 is fully seated with respect to the valve body 102. This is desirable for preventing fluids from traveling toward the first opening 138 of the first conduit 136 instead of the traveling down the second conduit 158.

With reference to FIG. 4, the fourth section 194 extends along the longitudinal axis 106 from the third section to the second end 172 of the valve stem 104. The fourth section 194 can include a hexagonal cross or another cross section that corresponds with a tool commonly used in the automotive industry. The fourth section 194 can be configured to actuate the valve stem 104 during assembly and control the depth of the valve stem 104 with respect to the longitudinal axis 106. In other words, an operator or machine with a hex bit can engage the fourth section 194 and actuate the valve stem 104 to a leak test position (FIG. 7) where the first seal 202 and the second seal straddle the first opening 160 of the second conduit 158.

In assembly, the first end 170 of the valve stem 104 is inserted into the second opening 140 of the first conduit 136 until the threads 192 of the valve stem 104 contact the threads 150 of the valve body 102. The valve stem 104 can be actuated (e.g., manually or by a machine) into the valve body 102 and with respect to the longitudinal axis 106 until the valve stem 104 is arranged in the leak test position (FIG. 7). In other words, the valve stem 104 can be actuated via the fourth section 194 until the first opening 160 of the second conduit 158 is arranged axially between the first seal 202 and the second seal 206 of the valve stem 104. At this point, the valve assembly 100 can be installed on the hydrogen fuel cell system 24. More specifically, the mounting flange 130 can be inserted into the vent 30 of the stack housing 28 and the valve assembly 100 can be secured to the valve housing with a fastener 128. The valve assembly 100 and, more particularly, the valve stem 104 is in the leak test position so the stack housing 28 or an external system (e.g., a stack housing ventilation system) can be pressurized with a fluid and will not be able to exhaust through the valve assembly 100.

Once leak testing of the hydrogen fuel cell system 24 is completed, an operator or machine can adjust the valve stem 104 to the vent position (FIGS. 8 and 9). In other words, the tool 32 (FIG. 12) can be inserted axially into the first opening 138 of the first conduit 136 and advanced toward the second end 112 until it engages with the slot 182 and the central opening 184. In the present illustrative embodiment, the tool 32 can be actuated counterclockwise to move the valve stem 104 toward the first end 110 of the first segment 108. The valve stem 104 can be advanced until the annular lip 208 bottoms out against the transition region 156 of the first conduit 136. As shown in FIG. 8, the head 180 and at least a portion of the annular groove 186 protrude from the first opening 138 of the first conduit 136 with respect to the longitudinal axis 106. The operator or machine can continue to rotate the tool 32 which will cause the head 180 to shear from the base 178 and expose the shear surface 188. The tool 32 is configured to catch or maintain in contact with the head 180 once the head separates from the valve stem 104. As mentioned above, removing the head 180 from the base 178 can be desirable preventing inadvertent closure of the valve stem 104 to the leak test position (FIG. 7).

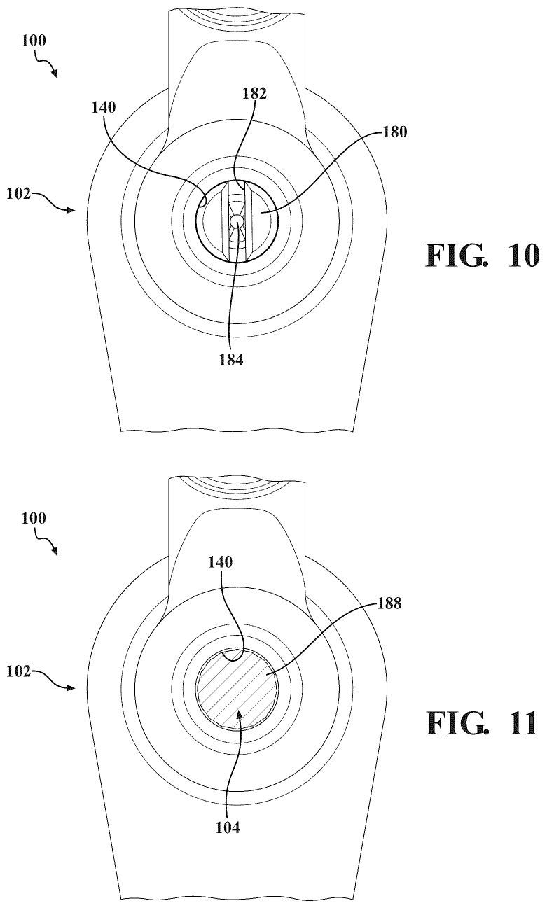

FIGS. 13-16 illustrate another illustrative configuration of a valve assembly 300. This configuration is similar in many respects to the configuration of FIGS. 1-12. Accordingly, the descriptions of the configurations are hereby incorporated into one another, and description of subject matter common to the configurations generally may not be repeated.

With reference to FIG. 13, the valve assembly 300 can be arranged in the vent 30 of the stack housing 28. The valve assembly 300 can be configured to secure (i.e., close off) the vent 30 for leak testing of the stack housing 28 and also serve as a purge valve once the hydrogen fuel cell system 24 is commissioned for normal operation.

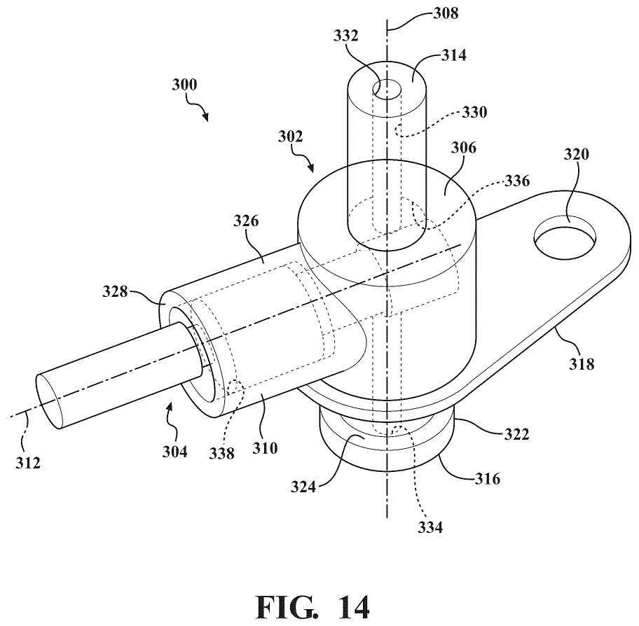

With reference to FIG. 14, the valve assembly 300 includes a valve body 302 and a valve stem 304 arranged in the valve body 302. The valve body 302 includes a first segment 306 extending along a first axis 308 and a second segment 310 extending along a second axis 312 that intersects the first axis 308. The first segment 306 extends between a first end 314 and a second end 316 spaced from the first end 314 with respect to the first axis 308. The first segment 306 is configured to receive hosing, tubing, piping, etc. on the first end 314 to carry a fluid toward and away from the valve assembly 300. The first segment 306 can have bracket 318 with one or more openings 320 for securing the valve assembly 300 to the stack housing 28 with one or more fasteners 321 (FIG. 13), for example. The first segment 306 can include a mounting flange 322 between the bracket 318 and the second end 316. The mounting flange 322 can have a seal groove 324 that is configured to receive an O-ring seal (not shown). The second segment 310 is communicatively coupled to the first segment 306 between the first end 314 and the second end 316 and extends from a proximal end 326 to the distal end 328 spaced from the proximal end 326 with respect to the second axis 312.

The first segment 306 includes a first conduit 330 that extends between a first opening 332 and a second opening 334 spaced from the first opening 332 with respect to the first axis 308. The first segment 306 also includes a central chamber 336 intersecting the first conduit 330 between the first opening 332 and the second opening 334. The second segment 310 includes a second conduit 338 that extends from a first opening 340 at the distal end 328 to a second opening 342 at the proximal end 326. The second conduit 338 intersects and is communicatively coupled to the central chamber 336. The second conduit 338 includes a threaded portion 344 that extends between the first opening 340 and the second opening 342.

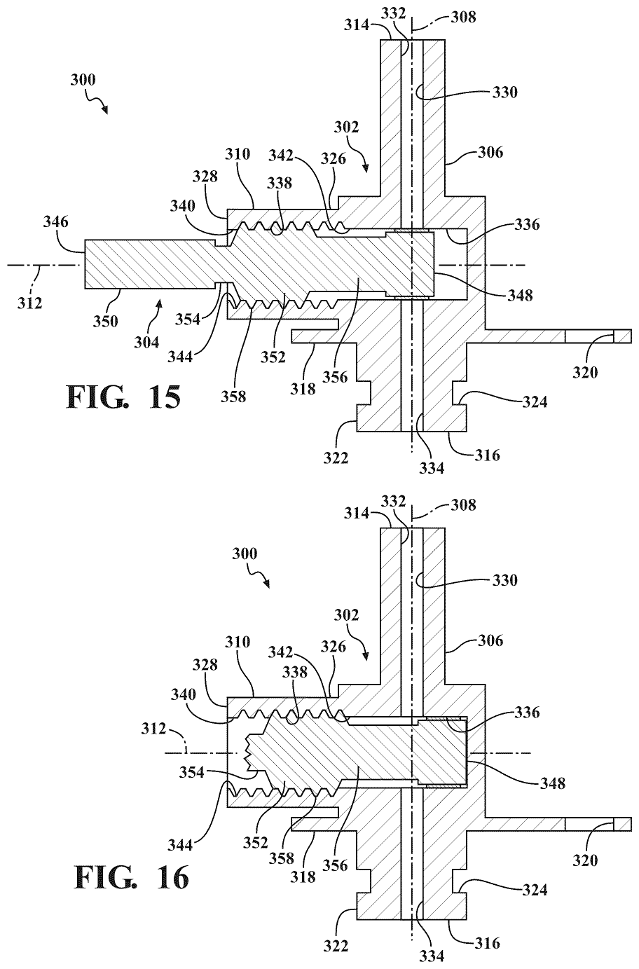

With reference again to FIG. 14, the valve stem 304 includes a first end 346 and a second end 348 spaced from the first end 346 with respect to the second axis 312. The valve stem 304 includes one or more sections between the first end 346 and the second end 348, as shown in FIG. 15. For instance, a first section or valve stem head 350 extends along the second axis 312 between the first end 346 and a second section 352. The first section 350 can be configured to actuate the valve stem 304 with respect to the second axis 312. In other words, the first section 350 can have a hexagonal cross section that corresponds with a hex bit or another cross section that corresponds with another tool commonly used in the automotive industry. In general, the first section 350 can be configured to shear off of the second section 352 once the valve stem 304 is fully seated within the valve body 302. In the present illustrative configuration, the valve stem 304 can include an annular groove 354 arranged axially between the first section 350 and the second section 352. The second section 352 extends along the second axis 312 between the first section 350 and/or annular groove 354 and a third section 356. The second section 352 includes a threaded portion 358 that corresponds with the threaded portion 344 of the second conduit 338. The third section 356 extends along the second axis 312 between the second section 352 and the second end 348 of the valve stem 304. The third section 356 is configured to interrupt fluid from flowing along the first conduit 330 between the first opening 332 and the second opening 334 when the valve stem 304 is in a first position (FIG. 15). The first position (FIG. 15) of the valve stem 304 may also be referred to a leak testing position and is configured to prevent fluid from escaping the stack housing 28 via the vent 30 while the stack housing 28 is being evaluated for leaks and also prevent fluid from flowing to the stack housing 28 while an external system (e.g., a ventilation stack housing system) is being tested for leaks. The third section 356 is configured to allow fluid to flow along the first conduit 330 between the first opening 332 and the second opening 334 once the valve stem 304 is advanced to the second position (FIG. 16). As indicated above, once the valve stem 304 is fully seated (i.e., arranged in the second position), the first section 350 can shear (i.e., break off) from the second section 352. In doing so, the valve stem 304 cannot be easily returned to the first position (FIG. 15) which can be desirable to prevent an inadvertent closure of the fluid pathway along the first conduit 330.

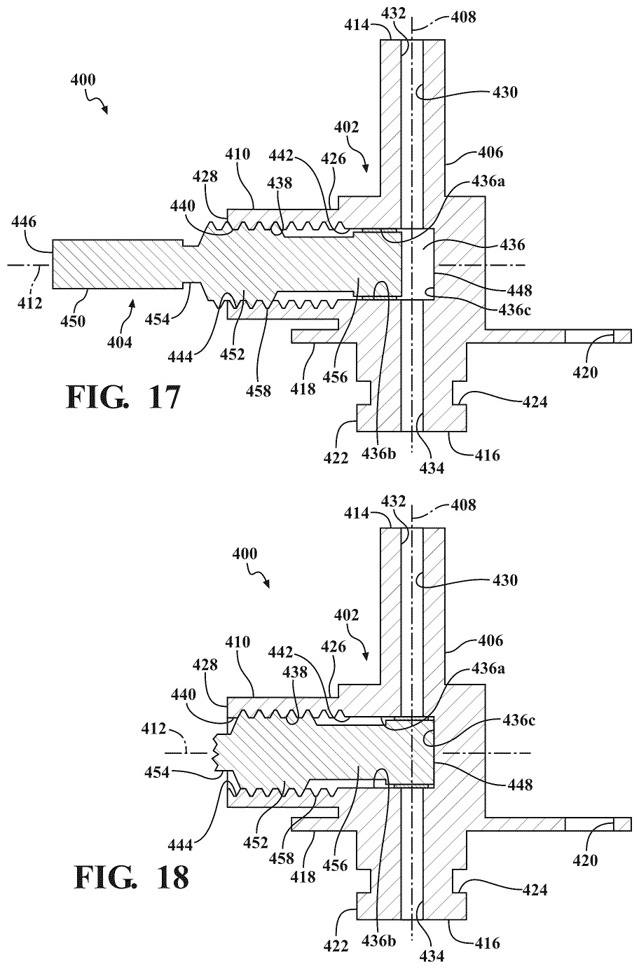

FIGS. 17-18 illustrate another illustrative configuration of a valve assembly 400. This configuration is similar in many respects to the configuration of FIGS. 1-12 and FIGS. 13-16. Accordingly, the descriptions of the configurations are hereby incorporated into one another, and description of subject matter common to the configurations generally may not be repeated.

With reference to FIG. 17, the valve assembly 400 can be arranged in the vent 30 of the stack housing 28. The valve assembly 400 is a multi-purpose valve that operates as a purge valve in one position and a plug that block flow in another position.

The valve assembly 400 includes a valve body 402 and a valve stem 404 arranged in the valve body 402. The valve body 402 includes a first segment 406 extending along a first axis 408 and a second segment 410 extending along a second axis 412 that intersects the first axis 408. The first segment 406 extends between a first end 414 and a second end 416 spaced from the first end 414 with respect to the first axis 408. The first segment 406 is configured to receive hosing, tubing, piping, etc. on the first end 414 to carry a fluid toward or away from the valve assembly 400. The first segment 406 can have bracket 418 with one or more openings 420 for securing the valve assembly 400 to the stack housing 28 with one or more fasteners, for example. The first segment 406 can include a mounting flange 422 between the bracket 418 and the second end 416. The mounting flange 422 can have a seal groove 424 that is configured to receive an O-ring seal (not shown). The second segment 410 is communicatively coupled to the first segment 406 between the first end 414 and the second end 416 and extends from a proximal end 426 to the distal end 428 spaced from the proximal end 426 with respect to the second axis 412.

The first segment 406 includes a first conduit 430 that extend between a first opening 432 and a second opening 434 spaced from the first opening 432 with respect to the first axis 408. The first segment 406 also includes a central chamber 436 intersecting the first conduit 430 between the first opening 432 and the second opening 434. The central chamber 436 includes a first wall 436a, a second wall 436b spaced from the first wall 436a, and an end wall 436c extending between the first wall 436a and the second wall 436b. The second segment 410 includes a second conduit 438 that extends from a first opening 440 at the distal end 428 to a second opening 442 at the proximal end 426. The second conduit 438 intersects and is communicatively coupled to the central chamber 436. The second conduit 438 includes a threaded portion 444 that extends between the first opening 440 and the second opening 442.

The valve stem 404 includes a first end 446 and a second end 448 spaced from the first end 446 with respect to the second axis 412. The valve stem 404 includes one or more sections between the first end 446 and the second end 448, as shown in FIG. 17. For instance, a first section or valve stem head 450 extends along the second axis 412 between the first end 446 and a second section 452. The first section 450 can be configured to actuate the valve stem 404 with respect to the second axis 412. In other words, the first section 450 can have a hexagonal cross section that corresponds with a hex bit or another cross section that corresponds with another tool commonly used in the automotive industry. In general, the first section 450 can be configured to shear off of the second section 452 once the valve stem 404 is fully seated within the valve body 402. In the present illustrative configuration, the valve stem 404 can include an annular groove 454 arranged axially between the first section 450 and the second section 452. The second section 452 extends along the second axis 412 between the first section 450 and/or annular groove 454 and a third section 456. The second section 452 includes a threaded portion 458 that correspond with the threaded portion 444 of the second conduit 438. A third section 456 extends along the second axis 412 between the second section 452 and the second end 448 of the valve stem 404. In other words, a portion of the third section 456 defines the second end 448 of the valve stem 404. The third section 456 is configured to allow fluid to flow along the first conduit 430 between the first opening 432 and the second opening 434 so long as the second end is spaced from the end wall 436c of the central chamber 436. Once the valve stem 404 is advanced to the second position (FIG. 18), the third section 456 interrupts fluid from flowing along the first conduit 430 between the first opening 432 and the second opening 434 when the valve stem 404. As indicated above, once the valve stem 404 is fully seated (i.e., arranged in the second position), the first section 450 can shear (i.e., break off) from the second section 452. In doing so, the valve stem 404 cannot be easily returned to the first position (FIG. 17) which can be desirable to prevent an inadvertent opening of the fluid pathway along the first conduit 430. A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A valve assembly, comprising:
a valve body, comprising:
a first conduit extending between a first opening of the first conduit and a second opening of the first conduit with respect to a first axis, and
a second conduit communicatively coupled to the first conduit and extending along a second axis between a first opening of the second conduit and a second opening of the second conduit spaced from the first opening of the second conduit; and
a valve stem extending between a first end and a second end with respect to the first axis, the valve stem being arranged in the first conduit with respect to the first axis and movable between a first position and a second position.

2. The valve assembly of claim 1, wherein the valve stem includes a first seal and a second seal spaced from the first seal.

3. The valve assembly of claim 2, wherein the valve stem is in the first position when the first opening of the second conduit is axially between the first seal and the second seal.

4. The valve assembly of claim 3, wherein the valve stem is in the second position when the first seal and the second seal are axially between the first opening of the first conduit and the first opening of the second conduit.

5. The valve assembly of claim 4, wherein the first position of the valve stem prevents fluid flow from the second opening of the first conduit to the second conduit and from the second conduit to the second opening of the first conduit.

6. The valve assembly of claim 5, wherein the second position of the valve stem allows fluid flow between the second opening of the first conduit to the second conduit.

7. The valve assembly of claim 1, wherein the valve stem includes a base and a head coupled to the base.

8. The valve assembly of claim 7, wherein the valve stem includes an annular groove arranged axially between the head and the base with respect to the first axis.

9. The valve assembly of claim 8, wherein the head is shearable from the base along the annular groove when valve stem is in the second position.

10. The valve assembly of claim 9, wherein the valve stem cannot return to the first position from the second position.

11. A valve assembly, comprising:
a valve body, comprising:
a first conduit extending between a first opening of the first conduit and a second opening of the first conduit with respect to a first axis, and
a second conduit communicatively coupled to the first conduit and extending transverse to the first conduit along a second axis between a first opening of the second conduit and a second opening of the second conduit spaced from the first opening of the second conduit; and
a valve stem extending between a first end and a second end with respect to the second axis, the valve stem being arranged in the second conduit with respect to the second axis and movable between a first position and a second position.

12. The valve assembly of claim 11, wherein the second conduit includes a threaded portion extending between the first opening of the second conduit and the second opening of the second conduit.

13. The valve assembly of claim 12, wherein the valve stem includes a first segment coupled to a second segment that includes a threaded portion that corresponds with the threaded portion of the second conduit.

14. The valve assembly of claim 13, wherein the valve stem interrupts flow between the first opening of the first conduit and the second opening of the first conduit when the arranged in the first position.

15. The valve assembly of claim 13, wherein the valve stem allows flow between the first opening of the first conduit and the second opening of the first conduit when the arranged in the first position.

16. The valve assembly of claim 13, wherein the first segment of the valve stem is shearable from the second segment of the valve stem in the second position.

17. A vehicle, comprising:
a vehicle body extending between a first end and second end;
a power reservoir coupled to the vehicle body;
an electric motor coupled to the vehicle body and communicatively coupled to the power reservoir; and
a hydrogen fuel cell system coupled to the vehicle body and communicatively coupled to the power reservoir, the hydrogen fuel cell system comprising:
a stack housing including one or more openings,
a valve assembly arranged in one of the one or more openings, the valve assembly comprising:
a valve body, comprising:
a first segment extending along a first axis between a first end and a second end,
a second segment communicatively coupled to the first segment between the first end and the second end, and
a valve stem arranged in the first segment and between a first position and a second position with respect to the first axis.

18. The vehicle of claim 17, wherein the first position of the valve stem prevents fluid flow from the stack housing to the second segment and from the second segment to the stack housing.

19. The vehicle of claim 18, wherein the second position of the valve stem allows fluid flow between the stack housing to the second segment.

20. The vehicle of claim 19, wherein the valve stem cannot return to the first position from the second position.
